(19) United States
(12) Patent Application Publication
(10) Pub. No.: US 2019/0152849 A1
(43) Pub. Date: May 23, 2019

(54) CABLE MADE OF FILAMENTS, METHOD AND APPARATUS FOR PRODUCING SUCH A CABLE AND A CONCRETE-COMPOSITE STRUCTURE CONTAINING THE CABLE AND SAID STRUCTURE

(71) Applicant: FERENC ATILA SCURGAI, CEGLED (HU)

(72) Inventor: FERENC ATILA SCURGAI, CEGLED (HU)

(21) Appl. No.: 16/092,647

(22) PCT Filed: Apr. 10, 2017
(86) PCT No.: PCT/HU2017/050010

§ 371 Date: Oct. 10, 2018

Related U.S. Application Data
(60) Provisional application No. 62/320,933, filed on Apr. 11, 2016.

(30) Foreign Application Priority Data
Apr. 7, 2017 (HU) P1700140

(51) Int. Cl. C04B 20/10; E04C 5/07; B05D 1/18; C04B 28/04; C04B 24/28; C04B 24/42; C04B 20/00

(52) U.S. Cl. CPC C04B 20/1077; E04C 5/073; B05D 1/18; C04B 2111/00482; C04B 24/283; C04B 24/42; C04B 20/0068; C04B 28/04

(57) ABSTRACT

This invention discloses an apparatus and method for producing a cable made of filaments embedded in a binding material (322) containing the steps of spreading the filaments of a strand (302) of filaments to obtain a band (310) of filaments, wetting the surfaces of the filaments in the band (310), coating the surfaces of the wetted filaments in the band (310), shaping continuously the cross section of the band (310) for creating a cable containing filaments embedded in a matrix of binding material (322). The invention also discloses a method to produce a concrete-composite structure made of reinforcement framework embedded in concrete, and the concrete-composite structure produced by that method.

This invention relates to an apparatus and method for producing a cable made of filaments embedded in a binding material, and the invention also discloses such a cable, a method to produce a concrete-composite structure made of reinforcement framework embedded in concrete, and the concrete-composite structure produced by that method.

Having advantageous properties, steel reinforced concrete structures have been spread worldwide to make buildings and support structures for buildings. Steel concrete structures bear the load acting thereto so that compression forces are accepted by the concrete, while tensile forces are accepted by the reinforcing steel. This dual behavior makes it possible to build steel reinforced structures suitable for different stresses to be accepted.

One of the problems of steel reinforced concrete structures is the reduction in co-working ability of concrete and reinforcing steel. One of the major problems with reinforced concrete structures is that phenomenon, when the slip-free joint between the concrete and the steel insert is reduced or eliminated. As a result of this problem, the support structure does not correspond to the static model calculated with baseline assumptions, i.e. the supporting structure loses its calculated load bearing capacity. Typically, a decrease in co-working is due to the corrosion of the iron insert. The formation of rust cleavages the surface bond and the surfaces of the two components, concrete and reinforced steel, are separated from each other actually. Oxidative corrosion of the steel insert occurs when it is exposed to air (oxygen) and moisture, typically in an environment at a pH 9.5 or less, in the case of a positive electrode potential. Spot corrosion occurs when water-soluble chemicals, such as chloride or nitrate, directly affect steel inserts. A typical phenomenon is the absorption of chlorides contained in winter melting salts in to supporting structures, such as bridges.

Another cause of this phenomenon is the corrosion of concrete. Due to the corrosion of the concrete, damaging environmental effects reach steel reinforcing inserts in steel reinforced concrete structures and the insert become rusty over time. Concrete corrosion is essentially caused the same external chemical effects. In cementitious concrete, free lime provides a high reaction value of pH 11-13 that preserves steel insert in concrete from oxidative corrosion. However, the free calcareous content of a concrete structure without surface protection is already attacked by 0.3% carbon dioxide content of the air, which is in the form of a carbonic acid in wet environment and causes carbonation. Similarly, free lime is also neutralized by aqueous solutions of aggressive oxides that pollute the atmosphere, i.e. sulfuric acid and nitric acid.

An undesirable process is the dissolution corrosion, which results in free lime releasing and carbonizing on the surface of the structure. This is a common phenomenon in wet buildings, retaining walls and structures of watercourses. Leaching of lime is critical when the lime content is completely consumed; the alkaline effect disappears from inside and causes rusting of iron inserts to start.

To reduce or delay concrete corrosion, the reinforced concrete supporting structure is made of more solid concrete, a disadvantage of which is that the cost of the structures is higher. There is a striving to ensure greater concrete coverage of the main steel inserts, which, however, has a disadvantage in optimizing when the structure's load capacity is statically calculated. There is a solution of this problem the surface protection of reinforced concrete supporting structures with paints and other materials, but these are costly operations having temporary results only.

A phenomenon inducing corrosion may be physical effect as well acting on the support structure. Due to frequently alternating loads, occasional overloads, shrinkage and swelling, cracks in the concrete structure are created, through which air and moisture reach the steel insert that begins to rust. In the structures exposed to the earthquakes, the density and extent of the cracks through which the steel inserts are attained by these environmental damages and their rusting are particularly frequent.

We can see that design and maintenance of conventional steel reinforced concrete structures for long-term durability expecting co-working of concrete and steel insert require special and costly measures. If any damage occurs, replacement or reinforcement of the supporting structures is required. A frequently used and successful technology for post reinforcement is an external reinforcement with fiber reinforced polymers for which carbon fiber ribbons are used. With their application, the bending and shearing capacity of slabs and reinforced concrete beams can be restored, but the solution is expensive.

Corrosion susceptible steel inserts can also be replaced by other materials. Coating of steel insets with epoxy resin as a solution has been developed, however, due to technical uncertainties and high costs of the technology it has not been used widely. Use of inserts made of stainless steel is extremely expensive and, therefore, their multitudinous application cannot be expected at this time.

In practice, some non-corrosive or corrosion-resistant polymer-based fiber reinforced inserts have now been introduced into use. The inserts consist of high-strength fibers placed in parallel arrangement bunched by embedding material. The fibers can be made of glass, aramid, basalt or carbon fiber. Among them, carbon fiber inserts have the most favorable mechanical properties and chemical resistance. The embedding material is generally thermosetting epoxy resin, polyester resin, or vinyl ester resin that adheres well to the fibers, but their disadvantage is that their heat resistance can only be increased up to 200° C. It should also be mentioned as a disadvantage that the epoxy resins are not resistant to the strongly alkaline effect of the concrete. Furthermore, it is a disadvantage that the pull-out test of fiber-reinforced polymer inserts shows that fibers can be made co-working with the concrete by using complicated techniques only. Solutions have been developed to use fibers provided by different surfaces, patterns and bending threads as anchoring support, which is now considered to be a widely known technology. However, its costs are considerable and in practice, its application has not spread widely.

Short fibers to be mixed with concrete are made of steel, polypropylene, glass, aramid, basalt and carbon, and combinations thereof. This short type of fiber, however, can substitute steel reinforcing bars used for tensile forces only a limited extent. Applying carbon-fiber cement-matrix (CFCM) composites for construction purposes has many years of experimentation, but they have not been applied widely to the supporting structures.

From the point of view of design calculation and requirements, the use of steel reinforced concrete structures is well supported by theories and standards based on practical experience. Standards override the optimal design possibilities due to properties of steel reinforced concrete. For example, it is necessary to specify the thickness of the concrete cover, which results in a lower moment arm between the depressed zone and the axle of the tensioned steel bar. The minimum distance of wire wrappings is also given in a design process, regardless of the statically calculated distance.

Reinforcement assembly on conventional reinforced concrete supporting structures is also a demanding process, so it is slow and expensive.

Reinforcement in reinforced concrete structures also represents a significant weight in comparison to the specific weight of the concrete. The specific weight of normal concrete is 23 kN per cubic meter, the mean specific weight of the concrete is 78 kN per cubic meter, which is a three-fold difference. In a stronger reinforced bearing structure, the weight is disadvantageous to the design, construction and operation of the entire structure.

Thus, the object of the present invention is to provide, instead of the conventional reinforced concrete support structures, the construction of supporting structures, which eliminate all the defects of the steel reinforced concrete, and are permanently capable of being used to bear the intended stresses, and concrete-composite load-bearing structures having less cross-section, better heat-resistance and practically unlimited lifetime can be created more efficiently and cheaply as compared to the prior art solutions, which allow damaged reinforced concrete structures to be repaired and other concrete composite works such as sculptures to create.

I have recognized that the steel reinforced concrete structures, in which pressure is borne by the concrete and the pulling forces are borne by the reinforcing steel bars, are to be replaced by composite materials, whose co-working is based on a chemical bond, and therefore, this co-working of the supporting structures is permanently maintained under all circumstances.

Tests conducted were proving that, if properly coated and impregnated carbon fibers and/or aramid fibers and/or basalt fiber cables are embedded in concrete for bearing pulling forces, they will be inextricably bonded with the concrete, and the desired co-working is ensured. This recognition led to the construction of fiber-cement matrix cables and concrete-composite structures by inserting that cables into concrete.

My further perception is that the properly treated carbon fiber, aramid fiber, basalt fiber cables are suitable for making two and three dimensional frameworks that form concrete composites after placing them into formwork, then filling it by concrete and allow to solidify. The use of frameworks in the construction of composite concrete supporting structures has several technical and economic benefits, the strength of concrete composite structures is higher, the weight is smaller, and are more resistant to corrosion and heat.

Above objective can be achieved by a method according to the invention for producing a cable made of filaments embedded in a matrix of binding material, and the method contains the steps of
spreading independent filaments of a strand of filaments to obtain a band of filaments,
wetting the surfaces of filaments in the band,
coating the surfaces of wetted filaments in the band with a binding material,
shaping continuously the cross section of the band of filaments having surfaces coated with binding material for creating a cable containing filaments embedded in a matrix of binding material.

The filaments arte chosen from a group consisting of carbon filament, aramid filament and basalt filament.

Wetting step is performed by a liquid emulsive dispersion, bathing the band of filaments in said dispersion for at least 3-20 s, advantageously for 10 s, and agitating the band while bathing, and maintaining the temperature of said emulsive dispersion (314) between 15 and 24° C.

The emulsive dispersion contains anionic tenside on a base of acrylic acid-esther and having low viscosity.

Binding material is chosen from a group consisting of cement paste and geopolimer paste, and using a dispersion as cement paste containing Portland cement, coal dust-ash and a liquid.

The cement paste contains 85 w % Portland cement having a grain size of 5-20 μm, coal dust-ash having a grain size below 10 μm in a quantity of 5-30 w %, preferably 20 w % of the Portland cement, and a mixture containing water and a plasticizer in a base of poly carboxilate-ether in a quantity of 03-1.8 w % of the water and silicone oil as foam suppressor agent in a quantity of 0.05-0.2 w % of the water used.

Coating the wetted surface of the filaments in the band with the binding material is performed by dipping the band into cement paste, while moving the band in the cement paste.

The cable consisting of filaments embedded into a matrix of binding material is winded onto a pulling reel.

A vapourtight casing on the pulling reel with cable winded thereon is provided.

Moreover, our objective can be achieved also by providing a cable containing filaments embedded in a binding material made by the method according to the invention, the filament is chosen from the group containing carbon fiber, aramid fiber, basalt fiber or a combination thereof, and the binding material is chosen from the group containing cement paste, geopolimer paste or a combination thereof.

Further, the invention provides a method for producing a concrete-composite structure made of concrete and a reinforcement framework embedded in the concrete, containing the steps of making a formwork, placing a reinforcement framework in the formwork, filling the formwork with liquid state concrete and allowing the concrete to set, and the method further comprising the steps of:
outspreading independent filaments of a strand consisting of filaments into a band, then
wetting the surfaces of filaments in the band consisting of filaments,
coating the surfaces of filaments in the band consisting of filaments having wetted surfaces by a binding material,
shaping continuously of cross section of the band consisting of filaments embedded in said binding material to form a cable containing filaments embedded in a matrix of binding material and having a closed cross section, and
placing the cable in a formwork.

Creating a reinforcement framework using the cable made of filaments embedded in a matrix of binding material before the binding material is set, and placing the framework in a formwork.

The framework made of the cable containing filaments embedded in a matrix of binding material is a straight section of cable loaded by tensile force after placed into the formwork.

Roughening the surface of the framework and allowing the binding material to set before placed in the formwork.

The filament is chosen from the group containing carbon fiber, aramid fiber, basalt fiber or a combination thereof, and the binding material is chosen from the group containing cement paste, geopolimer paste or a combination thereof.

Our objective can further be achieved by an apparatus according to the invention for producing a cable made of filaments embedded in a matrix of binding material, the apparatus contains idle rollers for guiding the filaments, and the apparatus further contains
a first unit provided by a drum having a breaking device and being suitable for storing and feeding a strand consisting of filaments, and
a second unit following the first unit, provided by an outspreading device for outspreading the filaments of the strand consisting of filaments into a band, and
a third unit following the second unit, provided by a tank for receiving a liquid emulsive dispersion for wetting the filaments of the band, and
a fourth unit following the third unit, provided by a tank for receiving a binding material for coating the filaments of the band, and
a fifth unit following the fourth unit, provided by a device for shaping continuously the cross section of the band of filaments having surfaces coated with binding material to form a cable, and
a sixth unit following the fifth unit, provided by a driven drawing reel for pulling the cable having a shaped cross section.

The outspreading device is formed by blocks having square cross section.

Guide rolls are arranged in the tank for receiving a binding material for coating the filaments of the band.

The device for shaping is formed as a drawing slit having a rounded, square or oblique cross section.

The device for shaping is formed as a pair of rollers rotating oppositely on the skirts of each other, both having circumferential grooves forming together the drawing slit.

A concrete-composite structure made by the method according to the invention is also disclosed, wherein the filament is chosen from the group containing carbon fiber, aramid fiber, basalt fiber or a combination thereof, and the binding material is chosen from the group containing cement paste, geopolimer paste or a combination thereof.

Using the method according to the invention concrete composite structures, in which the composite material is concrete and co-working fiber composite cables, can be produced. The cables are made in accordance with the method and apparatus of the present invention, wherein fibers are coated and saturated with the concrete-conform composite binder according to the present invention. The cables, in a preferred embodiment, are placed directly into the support structure in raw state as pulled parts of the structure. Further use is to create frames in two or three dimensional designs. The finished frames, after binding, perform the static role according to the forces acting in the supporting structures, where they work together with the concrete, forming a composite.

The cables according to the invention are also suitable for making other composite materials such as sculptures.

The invention will now be described in details with reference to the accompanying drawings. In the drawing

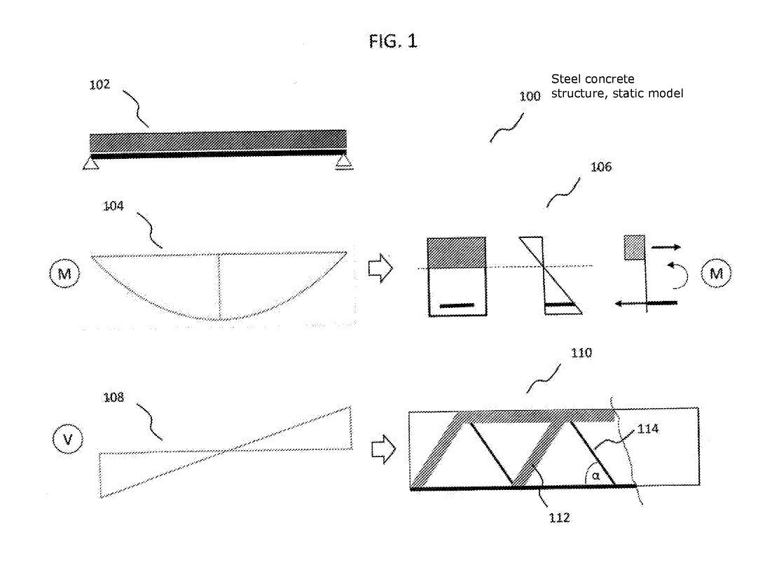

FIG. 1—static model of a reinforced concrete structures,

FIG. 1.04—a moment chart,

FIG. 1.06.—schematic diagram showing strength calculation,

FIG. 1.08.—diagram of shearing forces,

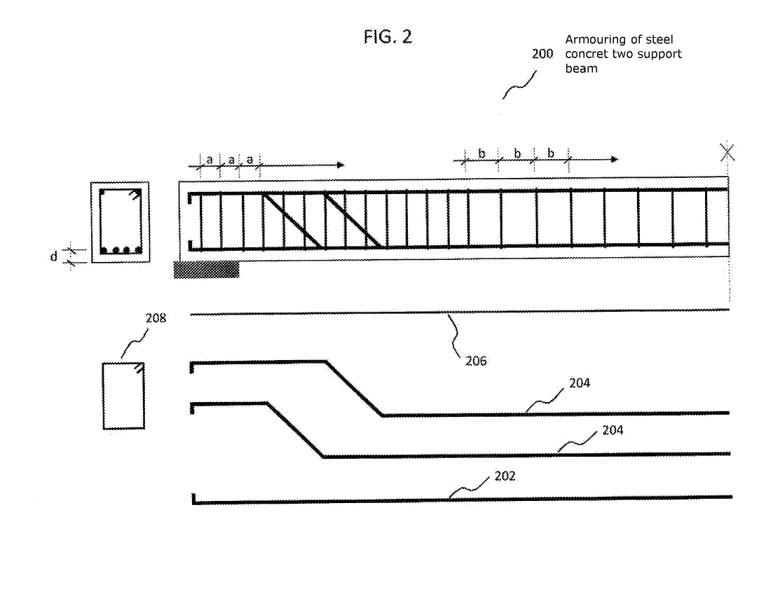

FIG. 2—steel reinforced concrete structure armouring example,

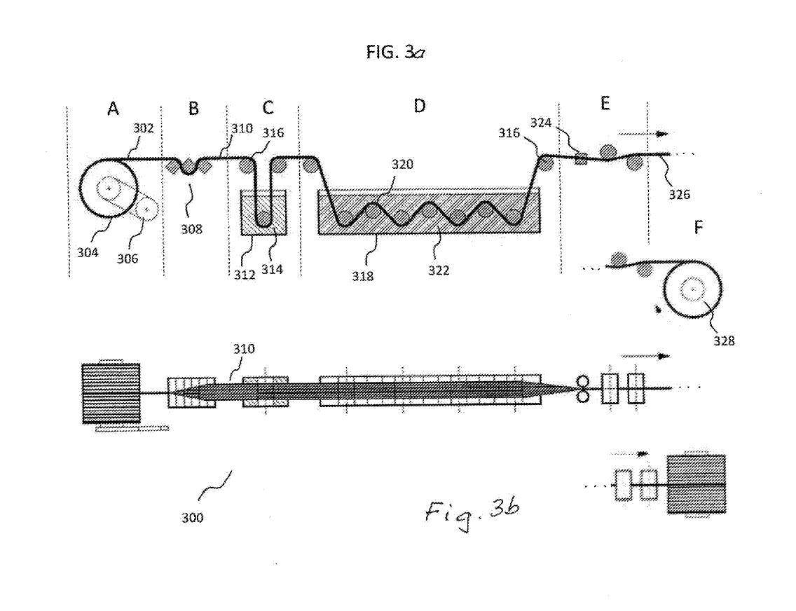

FIGS. 3a, 3b—depicts a preferred embodiment of the apparatus according to the invention, a

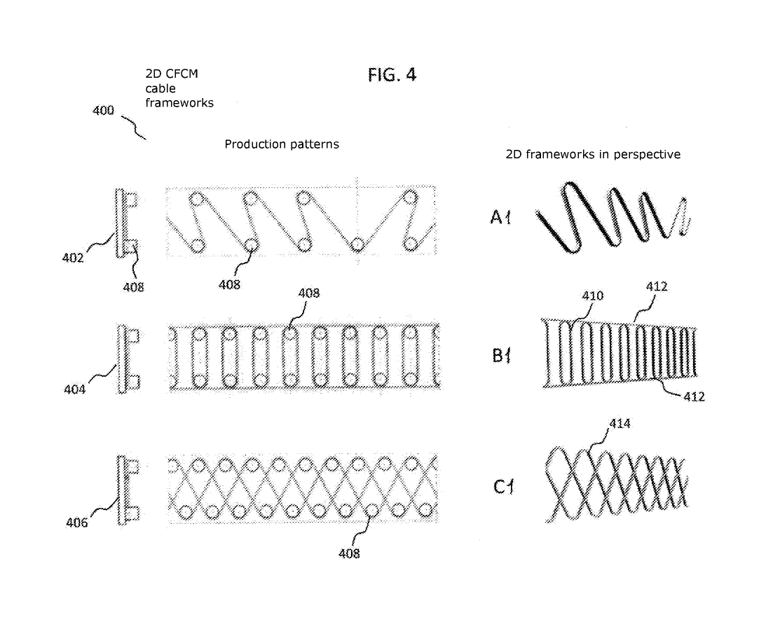

FIG. 4—is a schematic view of planar frames made of cables according to the invention;

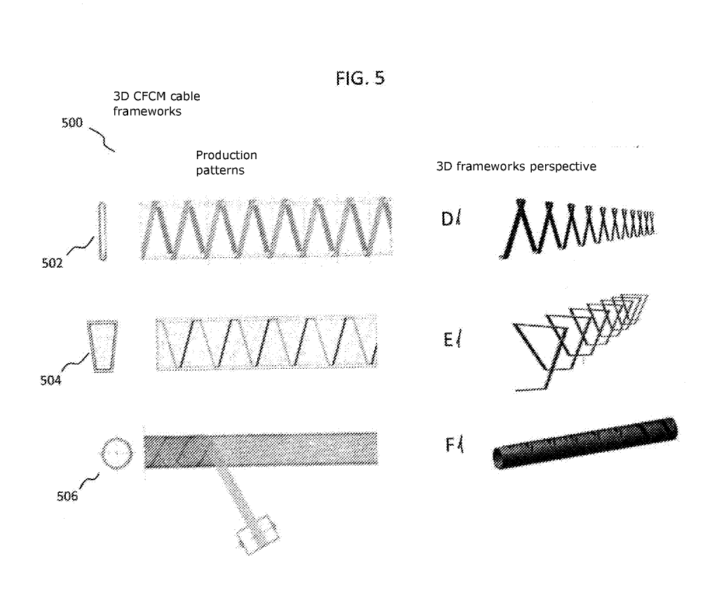

FIG. 5—is a schematic view of spatial frames made of the cable according to the invention;

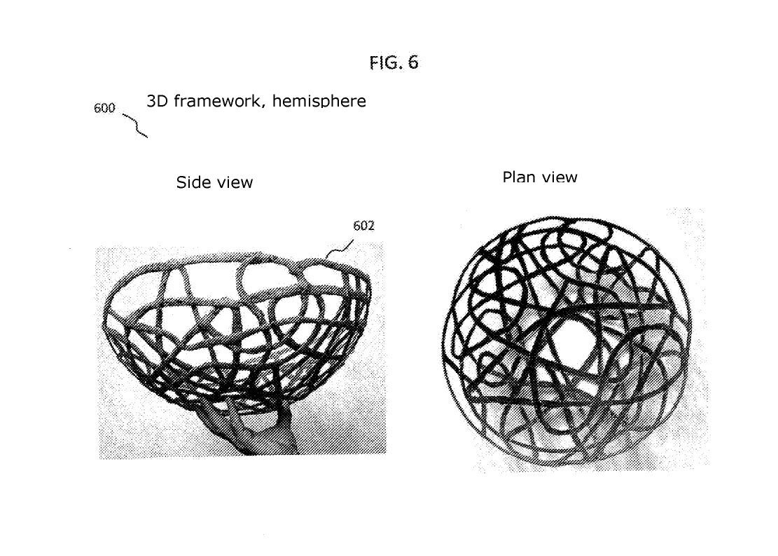

FIG. 6—a hemispherical frame made of the cable according to the invention,

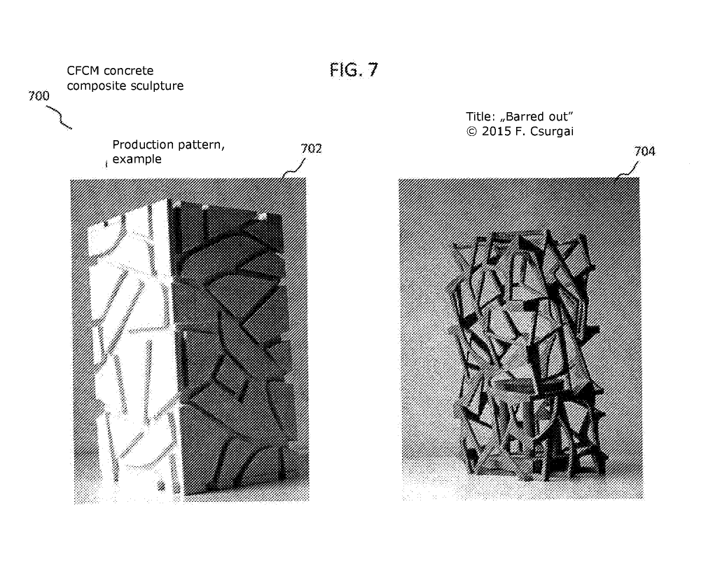

FIG. 7—a statue made of concrete composite according to the invention,

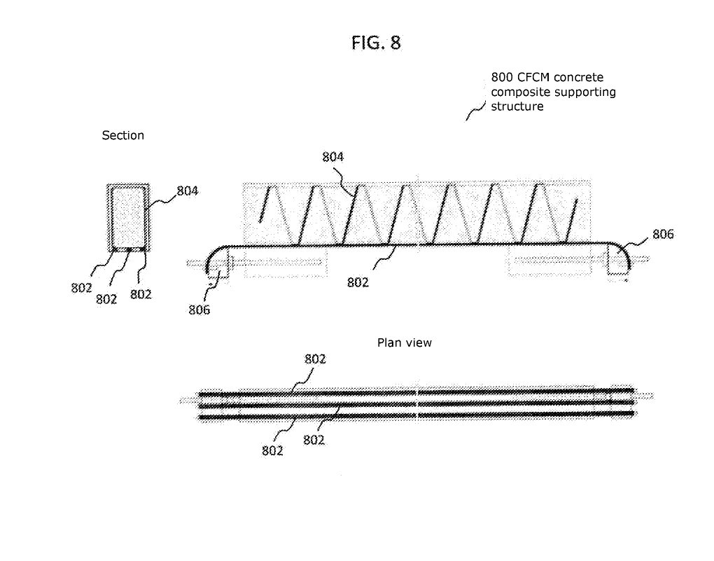

FIG. 8—shows a concrete composite according to the present invention having a rectangular cross section,

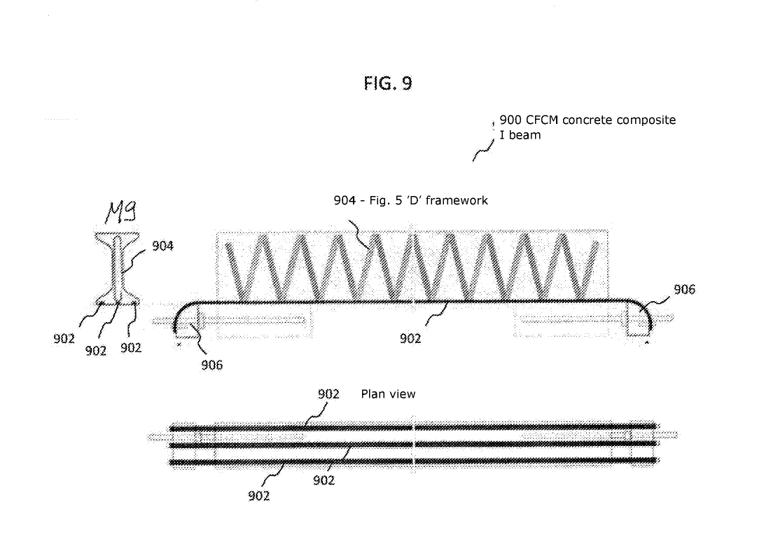

FIG. 9—shows a double tee beam made of concrete composite according to the invention, and

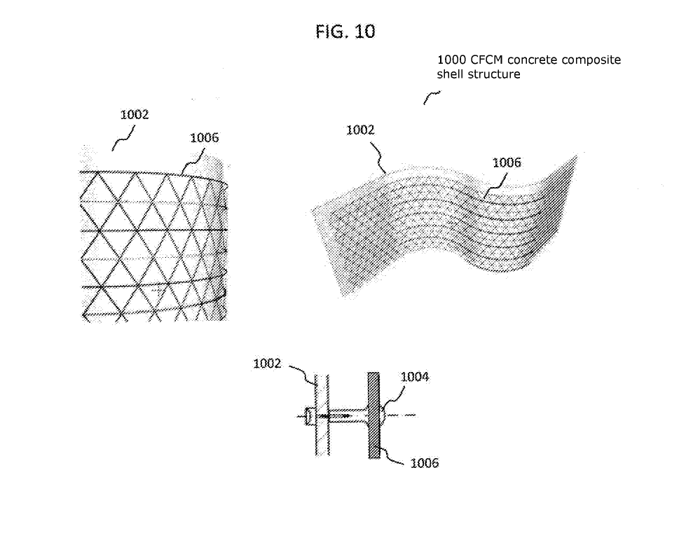

FIG. 10—shows a shell structure concrete made of concrete composite according to the present invention.

Steel reinforced concrete structures are dimensioned and designed according to different theories and standards, taking into account the materials and the safety levels. For example, a two support beam 102 shown in FIG. 1 is stressed with evenly distributed load. FIG. 1.04 of moments and FIG. 1.08 of shear force are commonly known in civil engineering practice. The valid principle of design of the beam for bending strength is the principle of plane cross-section, in which the concrete and steel work together without any slip, the load bearing capacity of the steel reinforced concrete is measured in a broken state—when the concrete bears pressure stresses only—and the concrete and the steel insert reach their limit stresses at the same time. In the schematic FIG. 1.06 depicting the design for bending it is shown that the compressive force applied to the cross-section is taken up by the concrete, the pulling force being absorbed by the steel insert. It is assumed that concrete and steel inserts work essentially together—similarly to the properties of a composite material. The same two support beam 102 can be sized for shear forces according to the trussed 110 support model, where the pressure is taken up by so-called pressed lattice bars 112 and the pulling force is taken up by drawn shearing 114 rods. The angle α of inclination of the bars is assumed to be between 22 and 45 degrees by taken into account the static model and the materials. In our calculations we usually take 45 degrees.

FIG. 2 shows the armouring of the two support beam 102. On the drawn side of the cross section there are the main bars 202 and main bars 204 bent upside, and mounting brackets 206 in the top corner. The longitudinal bars are joined by brackets 208. In accordance with the principles of design described above, the role of each reinforcing element is as follows. The main bars 202 are drawn. Given that the torque is smaller in the direction of supports, the pulling role of some of the main bars 202 is eliminated, so bent 204 main bars also play a role in bearing the shear forces, practically. The primary role of 208 brackets is to bear shear forces, secondarily to hold in place the longitudinal bars within the cross-section. According to the Eurocode standard, at least 50% of the shear forces shall be taken by brackets.

As shown in FIG. 2, the spacing of the brackets 208 varies: in the direction of the supports they are spaced from each other by a distance “a”, i.e. more densely, because the shear forces are greater there, and towards the middle of the beam they are spaced from each other by a distance “b”, that is rarely, since bearing of shear forces there is no longer their task. Allocation of the brackets 208 can always be determined by static calculation. The role of the mounting brackets 206 is nothing else than fixing the brackets in correct position while assembling. The steel reinforced concrete structure as shown is widely used in practice, but it has many problems that are largely unsolved to date or the solution is only partially or unfavorable in some aspects.

In this specification, the term “cable” refers to the bundle of fibers made of carbon, aramid or basalt material, in which the fibers are coated with a binder, i.e. the space between the fibers is filled with that binder. For example, the carbon fiber is stable and light, but at the same time it is five times stronger than steel, twice as rigid as it is, and it has a weight about one third to that of steel. However, it is strong, flexible enough as well. Carbon strands are factory made from carbon elemental fibers having a thickness of 5-8 micron. There are different types depending on how many elemental fibers are contained. Regular markings are 50K, 48K, 24K, 12K and so on. The 50K carbon strand contains 50,000 filaments, about 0.5 mm thick and 8 mm wide, with a rectangular cross section. In the examples of the invention 50K carbon strand was used, but this does not limit the use of any type of strand. The breaking elongation of the carbon fiber is 1.5% versus 18% of hot rolled steel, and 10% elongation of cold drawn steel. The carbon filament has a modulus of elasticity of 242 Gpa, the concrete reinforcing steel has 200 Gpa. The yield strength of the reinforcing steel is 500 N/mm², while the tensile strength of the carbon fiber is 4137 N/mm². The tensile strength of steel tensioning strands used in pre-fabricated reinforced concrete structures is only 1770 N/mm2, which is significantly lower than that of the carbon strand. Mechanical properties of the carbon fibers differ significantly from the properties of concrete reinforcement steel used in reinforced concrete support structures, that is more favorable they are, and therefore, they offer a wide range of possibilities to replace them using the technology according to the invention.

The carbon elemental fiber can be replaced by aramid or basalt fiber according to the invention. The aramid elemental fiber has lesser specific weight than carbon fiber but has a tensile strength matching that of the carbon fiber, while the tensile strength of basalt fiber having a composition similar to the glass is about half of the strength of carbon fiber, but its advantage is that its tensile strength does not decrease significantly with a significant increase in temperature.

As mentioned above composites e.g. CFCM-like materials are tested for many years, but are not known either any composite CFCM cable placed in cement-based matrix and consisting of substantially parallelly arranged carbon fibers, nor its structural use.

The cable according to the invention is produced by a device and method according to the invention, so that a carbon strand is ‘saturated’ by a binder, e.g. cement paste. FIGS. 3a and 3b show a schematic side views of an apparatus suitable for performing the method for producing a cable 326 according to the present invention, in a side view (FIG. 3a) and in plan view (FIG. 3b). The apparatus consists of six units A, B, C, D, E, F. The apparatus is intended for the production of a composite 326 cable according to the invention.

On a reel 304 in the unit A a strand 302 containing carbon, aramid or basalt fibers, in the illustrated embodiment made e.g. of carbon fibers, is available for the process, from which reel 304 the strand 302 is fed into the apparatus. Against a driven drum 328 providing pulling force, a braking unit 306 tensions the strand 302. The strand 302 is led by idle rotating rolls 316 in the apparatus.

Unit B outspreads the filaments of the 302 strand by means of an outspreading device 308. The outspreading device 308 consists of steel profiles of square cross-section in our experimental apparatus, but any other solution for spreading filaments known in the engineering practice is also suitable for this operation. A strip 310 of elementary fibers moves further from the unit B.

A dispersion 314 for wetting is disposed in unit C in a wetting tank 312, in which the strip 310 are pulled through.

Unit D is a container 318 for filling the strip 310 with a binder paste 322, e.g. cement paste, in which baffle rollers 320 are immersed in the binder paste 322. The strip 310 of stretched elemental fibers is saturated while advancing on the baffle rollers 320 so that the binder paste 322 is intrudes in between the elemental fibers. The length of the container 318 for binder paste 322 and the pulling speed of the strand 302 are adjusted so as to provide the required time for the corresponding saturation level. The binding of binder paste 322 can be retarded with known additives, e.g. by the addition of tartaric acid. Our experimental equipment was made with a 80 cm long cement paste 322 container 318, in which the pulled strand 302 was moved with a pulling force of 80-100 N, obtaining an average speed of 0.15 to 0.20 m/s. Each cross section of the strip 310 of elemental fibers thus stayed in the binder cement paste 322 for 8 to 10 seconds mean. The strip 310 of fibers has been perfectly saturated.

Unit E performs a cross-sectional shaping of the strip 310 of elemental fibers saturated with binder paste 322 by means of a forming device 324. The role of the forming device 324 is also to remove the excess cement paste 322 from the saturated strip 310. It is possible to make a formed 326 cable such that the forming device 324 conducts the saturated strip 310 of fibers in a shaping cross-section, which can be, for example, a square or rectangular or round slit. The forming device 324 contains preferably e.g. two rollers rolling on each other's skirt, each of which is provided with circumferential grooves forming a slit together. For example, a cable 326 of 6 mm in diameter with circular cross-section was made during our tests.

Unit F is a driven drawing reel 328 which pulls, and in this embodiment it is convenient to wrap the finished cable 326 still wet. The driven drawing reel 328 can be advantageously removed from the apparatus and can be transferred to the desired location of use with the reeled cable 326 thereon. The apparatus according to the invention may be made as an installed plant or as a mobile device. The whole apparatus as well as any of its units are exemplary and illustrate only the invention. The apparatus or its units can be realized in any desired embodiment.

In the first step of the process of the invention, the elemental fibers of the carbon strand 302 of non-bonded carbon fibers are spread out, i.e. the carbon strand 302 of the plurality of thousands of small diameter elemental fibers are appropriately loosened and spread out in order to intrude the binder paste in between the fibers. For example, a strand 302 consisting of carbon fiber of 50K used in our experiments was spread into a strip 310 having a cross section of 25 mm wide and 0.05 to 0.15 mm thick.

Subsequently, in the second step of the process, the strip 310 consisting of outspreaded elemental fibers is wetted in order to prepare the surface of the elemental fibers. An emulsifier is used for wetting, in which the elemental fibers are soaked for at least 5-8 seconds. For better wetting effect, the strip 310 is moved while bathing. In doing so, the temperature of the emulsifier is preferably maintained at a temperature of from 15 to 24° C. The emulsifier used in our experiments is an anionic surfactant based on acrylic ester based low viscosity 314 dispersion. This dispersion 314 conforms well to the Portland cement used in the concrete structures, so that it also has a pH value of 12-14. For surface preparation any other wettable material may be used if its properties are similar to the properties of dispersion 314 and fit into the highly alkaline environment.

In the next, third step of the process the strip 310 consisting of wetted filaments is saturated with a cement paste 322 binder material, in a preferred embodiment. Saturation is performed by immersion into the binder paste 322 and preferably by moving the strip 310 in the binder paste 322. The binder paste 322 e.g. cement paste used in the process of the present invention is a material containing Portland cement, coal dust-ash and a liquid, with a density of approximately that of honey, that is approx. 2.2 kg/dm³. The Portland cement type is preferably CEM I. 52.5 N-SR0, 85% of which has a particle size of 5-20 microns. Low particle size is an important factor to easier access in between carbon fibers. The added coal dust-ash is 5-30 weight %, preferably 20 w % of the cement mass, and its size is preferably below 10 microns. The liquid phase used is: water, polycarboxylate ether (PCE) based plasticizer agent in a quantity of 0.3-1.8% by weight of the water, and a foam suppressor agent containing silicone oil in a 0.05-0.2 w % quantity of the water. The bonding time of the cement pulp is an important condition, which may be slowed down by adding tartaric acid, for example. The cement paste 322 used conforms to the Portland cement binder of the concrete and a chemical bonding is formed between the two materials in a concrete-composite structure, when embedded. The established chemical bonding ensures that the cable 326 and the concrete behave together as a composite material. If a geopolymer is used as a binder of concrete instead of cement in the concrete composite structure, the strip 310 of elemental fibers should be saturated with geopolymer paste 322 instead of cement paste 322.

In the fourth step of the process the strip 310 of elemental fibers saturated with binding paste 322 is formed in its cross section so that the strip 310 of fibers saturated with cement paste 322/geopolymer paste 322 therebetween is merged in a cable 326 with desired cross-section, and the cable 326 saturated with binder paste 322 is ready for further use.

In our experiments we have made cable 326 having a cross section of a circle of 4 to 8 mm in diameter, using a 50K carbon strand 302, but cable 326 can be of any diameter.

The finished wet 326 cable is flexible and bendable. It can be made a straight bar, can be wrapped in any plane or spatial form, it can be folded, spun and threaded before solidification. This excellent feature allows it to be used for bearing tensile forces, shearing and twisting loads in support constructions or in other constructions made of concrete, according to calculations of dynamics.

One of the ways of using the 326 cable is to provide a concrete composite structure according to the invention, i.e. a arranging a wet, that is flexible 326 cable in a formwork to be filled, another way of use is creating prefabricated shapes, armatures or frames made of 326 cable allowed to harden before use. Generally, both uses are combined. Due to its low water/cement rate, the wet 326 cable must be protected against dehydration before use, for example, the reel 328 must be wrapped by a vapor barrier material carefully, i.e. by foil packaging. Use in wet condition should preferably take place within 3-5 hours counted from the the shaping operation.

In solidified state, the cable 326 is a solid, flexible, non-vulnerable fiber with a specific gravity of significantly less than that of steel. With static load, it acts linear flexibly until it breaks by brittle fracture. Unlike steel it does not show any yield. Its tensile strength generally exceeds substantially that of steel and it can reach 4000 N/mm2. Its modulus of elasticity and its elongation is less than that of steel. It has excellent fatigue strength, low creep and relaxation. Due to the properties of cable 326, it is an excellent material for the manufacture of armatures that can be used in supporting structures.

The cable 326 is suitable for the production of a concrete composite according to the invention, in which the concrete takes up the pressing load, while the tensile, shear and torsion stresses are taken up by the cables 326. In the concrete composite material, the bonding agent of the concrete and the binder material of cables 326 are bonded chemically to each other. During its application in supporting structures the co-working of the two materials is ensured, they do not separate from each other. Its behavior is similar to that of reinforced concrete supporting structures prior to any damage. The quality of concrete may vary according to static calculations. Preferably, high strength or ultra-high strength concrete is used.

When preparing the concrete-composite structure according to the invention, the concrete casting is done after arranging and tensioning of the wet cable 326 in the formwork. After-treatment of concrete is in accordance of the concrete technology.

The cable 326 saturated with binder material is suitable for subsequently reinforcing and providing corrosion protection of supporting structures e.g. reinforced concrete structures. Cable 326 bundles built in deepen groves or rollover of the support structure on its cleaned and adhesive padded surface, ensure the existence of structure and increase its usefulness.

Cable 326 is also suitable for the manufacture of armors or frameworks according to the invention. The framework made of cable 326 is a rigid frame that can be manufactured in any form for concrete composite supporting structures, artworks and other purposes.

The production of frameworks takes place by winding, stapling, spinning and stitching or by similar applying the wet-state cable 326 on to a preformed pattern. Following these operations, when the framework is almost solidified and movable, it is separated from the pattern, placed in a formwork and concreted in. If the perfect solidification has not yet occurred then we use auxiliary equipment adapted to the framework to move.

In the case of concreting in a frame made of the 326 cable before the binder paste 322 completely solidified, concrete and the bonding paste 322 of the wet 326 cable come with one another in a chemical bond. Thus, if the wet cable 326 is in contact with the liquid state concrete during concreting, the bonding of the cement crystals creates a perfect chemical bond, as the two materials, that is the cement-based binder and the binder of concrete form a crystal structure during the hydration of the elemental fibers, which results in perfect bonding. In case of two differently aged concrete this perfect chemical connection cannot be achieved at the level of crystal structure. This chemical bond also provides additional benefits, because there is no tension between the two materials. The shrinkage of the cement is the most intense in the early phase. If there is a large difference between the times of concreting operations, the shrinkage of the two layers will be significantly different and even separation may occur. By concreting in the wet cable 326 the stress due to shrinkage between two different materials having identical chemical properties at the same time, can be reduced to a minimum.

When transporting the framework to a distant workplace, it is protected from damage by a vapourtight casing avoiding dehydration and ensuring easy handling. After placing in the formwork, the packaging is removed. Depending on the nature of the framework, packaging can be made of wood, plastic, hard paper or plastic foil.

When planning for later use, the surface of the 326 cable to be used to make the frameworks is roughened still in fresh and wet state. Roughening may be, for example, sand blasting with quartz sand having a particle size of max. 0.3 mm. The purpose of roughening is to ensure that connection of concrete and the framework in the concrete-composite be performed even if the chemical bond between the components is created partially only or not at all. When constructing concrete composite support structures, the cables 326 are placed in the formwork in a raw and/or solidified state. After concreting and setting, such a structure is capable of carrying loads.

The frameworks can be made with a flat and spatial design. FIGS. 4 to 7 show examples of fabrication and construction of frameworks. It will be emphasized that by the method of the present invention frameworks of any shape and strength can be made using the cable 326.

FIG. 4 shows examples of planar frameworks A1, B1, C1 made of cables 326. In all three cases, the cable 326 is wound up in a wet state to produce the required form into a series of cylindrical members 408 fixed on the surface of a pattern 402,404,406. The cylindrical members 408 are arranged in the first pattern 402 so that the finished framework A1 is made with branches extending in 45°. This framework A1 can advantageously be used to bear shear forces generated in a two support beam made of a concrete-composite.

The frequency and arrangement of the cylindrical members 408 arranged on the surface of the second pattern 404 is such that winding the cable 326 thereto several times a stronger framework B1 can be created. The finished B1 armature is such that the parallel vertical bars 410 are joined by horizontal bars 412 running below and over as well.

In the third pattern 406 a lattice type framework C1 having bars 414 inclining in 45° in both directions can be made. This method enables the production of a fiber reinforced planar framework of cables 326 textured arbitrarily on a universal production pattern. The self-supporting framework can be removed from the pattern by separating it from its surface. The method is facilitated by temporarily removing the cylindrical members 408.

FIG. 5 shows examples for spatial frameworks D1, E1, F1 made of cables 326. These frameworks D1, E1, F1 are designed to wrap the wet cable 326 into the spatial 502,504,506 pattern in a desired direction. Winding can be single or multiple, one-way or multi-directional. The spatial framework D1, E1, F1 may also be made in such a way that one of its sections has multiple windings and therefore stronger than the other section.

It is also possible to make a statically perfectly self supporting framework D1, E1, F1 of cable 326, such as a framework F1 with circle, ellipse or polygonal cross-section.

Separation of frameworks D1, E1, F1 from spatial patterns 502,504,506, is done for example by folding the 502,504,506 patterns manually or by a machine operation and then being removed from the frameworks D1, E1, F1. Separation occurs when the framework D1, E1, F1 is sufficiently self-supporting. The tubular framework F1 of FIG. 5 can be constructed as a self-supporting structure, which for example retains the formwork for the support structure of a column and also performs the static function of wire wrapping. In case of sufficient frequency it also functions as a shell. It can also be used to make concrete-composite pipes. Due to the freedom of manufacture of spatial 326 cable frameworks it is possible to create frameworks following precisely the pattern of static forces in a support structure, which also provides the modern, computer-aided design and implementation of concrete-composite mountings.

In FIG. 6, a special spatial cable 326 framework is shown in the side view and plan view, which is a hand-made hemisphere 602.

FIG. 7 illustrates the use of composite-concrete in the field of fine art, e.g. making concrete composite sculptures. When composing the sculptor's compositions, the pattern of the artwork is made first, and then the concrete-composite structure is built. When the composition material is solidified, the pattern will be removed. The material of the pattern can therefore be easily carved or chemically destroyed and can be easily removed from the inner space of the statue. In the Figure a picture of a sculpture production pattern 702 is shown made of lightweight insulation material and polystyrene by example. This concrete-composite sculpture 704 titled “Barred out” is the inventor's work, created in 2015. The method according to the invention can be used to produce abiding sculptures of any size for parks and public spaces. Technology requires a special ability of seeing in relief of the sculptor, because after the work has been dreamed up, it has to construct its negative pattern, which is an exciting process requiring great creativity.

Construction of frameworks according to the invention and their formal appearance are exemplified here and do not limit their application possibilities.

Preparation of concrete composite supporting structures and its formative possibilities are presented in three examples by drawings. FIG. 8 shows a simple supporting structure 800 having rectangular cross-section with two supports in top and sectional view. In the supporting structure 800 the pulling forces arising from the bending moment are taken up by longitudinal cables 802, and the shear forces are taken by a framework 804 made of cable 326. Tensioning of the longitudinal cables 802 is performed by tensioning means 806 located at two ends of the formwork. Tensioning means 806 are well known, hand-held or machine-driven devices. When making the supporting structure, the longitudinal cables 802 being in raw state are first placed in the formwork. As indicated in section M, the longitudinal cables 802 lie directly on the formwork, as they are not to be covered with concrete necessarily. After the tensioning means 806 are fixed the two ends of the longitudinal cables 802 are tensioned to the desired value. Tensioning in simpler cases serves only to keep the longitudinal cables 802 in place and parallel while tensioned. If the tension is applied to a predetermined value, the tension value is preferably measured by means of a force measuring device. Next step is to position the framework 806 made of cable 326 and then concreting in. When required strength of the concrete is reached, protruding ends of longitudinal cables 802 will be cut off and then the formwork can be disassembled. After the concrete is bonded perfectly the supporting structure becomes a load-bearing structure.

FIG. 9 shows an I-bar support beam comprising raw state longitudinal cables 902 and a reinforcement framework 904 made of cable 326. Accessories are also tensioning means 906 at both ends of the beam. The production process of the beam is the same as it is shown in FIG. 8.

A schematic view of a spatial shell made of concrete-composite can be seen in FIG. 10. Fasteners 1004 are inserted in the formwork 1002 of the shell structure 1004 in a given order, which retain a mesh 1006 made of cable 326. The mesh 1006 is made so that a wet cable 326 is secured to fixing members 1004 according to a predetermined path, and the mesh 1006 is formed. The uniform distribution is the basic way to form the mesh, but if the load bearing demands of a given shell structure so requires, an uneven, asymmetrical or irregular distribution can be made, too. After the mesh 1006 has been made accurately, concreting is followed. After the concrete is solidified, the concrete composite shell is completed.

The method described above allows to track the force dynamics of any shells designed with computer design and by static calculations, and construction of a shell. The possibilities can only be limited by the imagination of the designer. The method disclosed further enables follow-up reinforcement of any curved and complicated wall structure, concrete structure, retaining wall, grain silo, reservoir and other structures by means of the concrete composite according to the present invention.

Concrete-composite technology can be a new and extremely important application area for the construction of small, medium-sized or large containers for short and/or long-term storage of radioactive waste. Its extremely favorable mechanical properties and chemical stability make it suitable for this task even in an aggressive environment. Building of non-corrosive containers can be used for long-term storage of hazardous waste.

The major advantage of the present invention as compared to the prior art solutions is that the present invention provides concrete-composite structures having a high load bearing capacity by smaller cross section, better heat resistance and practically unlimited lifetime, eliminating the disadvantages of prior art steel reinforced concrete structures by means of using the cable 326 according to the invention. This possibility is particularly advantageous for the purpose to build supporting structures exposed on environmental pollution and in areas with frequent earthquake where damaging of today's conventional steel-concrete structures can be eliminated only by significant maintenance costs. The concrete composite technology of the present invention is an excellent opportunity for contemporary and future architects and civil engineers to formulate their structural and formal ideas. Structures defined by up to date and computerized planning and modeling of dynamics can be advantageously implemented using the technology of the present invention. Cables 326 are also suitable for creating other concrete composite artworks, such as sculptures.

1. Method for producing a cable made of filaments embedded in a matrix of binding material, characterized in that the method contains the steps of
spreading independent filaments of a strand (302) of filaments to obtain a band (310) of filaments,
wetting the surfaces of filaments in the band (310),
coating the surfaces of wetted filaments in the band (310) with a binding material (322),
shaping continuously the cross section of the band (310) of filaments having surfaces coated with binding material (322) for creating a cable (326) containing filaments embedded in a matrix of binding material (322).

2. The method according to claim 1, characterized in that choosing the filaments from a group consisting of carbon filament, aramid filament and basalt filament.

3. The method according to any of claims 1-2, characterized in that wetting is performed by a liquid emulsive dispersion (314), bathing the strip (310) of filaments in said dispersion (314) for at least 3-20 s, advantageously for 10 s.

4. The method according to claim 3, characterized in that agitating the band (310) while bathing, and maintaining the temperature of said emulsive dispersion (314) between 15 and 24° C.

5. The method according to claim 4, characterized in that said emulsive dispersion (314) contains anionic tenside on a base of acrylic acid-esther and having low viscosity.

6. The method according to any of claims 1-5, characterized in that choosing said binding material (322) from a group consisting of cement paste and geopolimer paste.

7. The method according to claim 6, characterized in that using a dispersion as cement paste containing Portland cement, coal dust-ash and a liquid.

8. The method according to claim 7, characterized in that said cement paste contains 85 w % Portland cement having a grain size of 5-20 μm, coal dust-ash having a grain size below 10 μm in a quantity of 5-30 w %, preferably 20 w % of the Portland cement, and a mixture containing water and a plasticizer in a base of poly carboxilate-ether in a quantity of 03-1.8 w % of the water and silicone oil as foam suppressor agent in a quantity of 0.05-0.2 w % of the water used.

9. The method according to any of claims 6-8, characterized in that coating the wetted surface of the filaments in the band (310) with the binding material (322) is performed by dipping the band (310) into cement paste, while moving the band (310) in the cement paste.

10. The method according to any of claims 1-9, characterized in that winding the cable (326) consisting of filaments embedded into a matrix of binding material onto a pulling reel (328).

11. The method according to claim 10, characterized in that providing a vapourtight casing on the pulling reel (328) with cable (326) winded thereon.

12. Cable containing filaments embedded in a binding material made by the method according to claims 1-11, characterized in that the filament is chosen from the group containing carbon fiber, aramid fiber, basalt fiber or a combination thereof, and the binding material (322) is chosen from the group containing cement paste, geopolimer paste or a combination thereof.

13. Method for producing a concrete-composite structure made of concrete and a reinforcement framework embedded in the concrete, containing the steps of making a formwork, placing a reinforcement framework in the formwork, filling the formwork with liquid state concrete and allowing the concrete to set, characterized in that the method further comprising the steps of:
outspreading independent filaments of a strand (302) consisting of filaments into a band (310), then
wetting the surfaces of filaments in the band (310) consisting of filaments,
coating the surfaces of filaments in the band (310) consisting of filaments having wetted surfaces by a binding material (322),
shaping continuously of cross section of the band (310) consisting of filaments embedded in said binding material (322) to form a cable (326) containing filaments embedded in a matrix of binding material (322) and having a closed cross section, and
placing the cable (326) in a formwork.

14. Method according to claim 13, characterized by creating a reinforcement framework using the cable (326) made of filaments embedded in a matrix of binding material (322) before the binding material (322) is set, and placing the framework in a formwork.

15. Method according to claim 13, characterized in that the framework made of the cable (326) containing filaments embedded in a matrix of binding material (322) is a straight section of cable (326) loaded by tensile force after placed into the formwork.

16. Method according to claim 14, characterized by roughening the surface of the framework and allowing the binding material (322) to set before placed in the formwork.

17. Method according to any of claims 13-16, characterized in that the filament is chosen from the group containing carbon fiber, aramid fiber, basalt fiber or a combination thereof, and the binding material (322) is chosen from the group containing cement paste, geopolimer paste or a combination thereof.

18. Apparatus for producing a cable (326) made of filaments embedded in a matrix of binding material (322), the apparatus contains idle rollers (316) for guiding the filaments, characterized in that the apparatus further contains
a first unit (A) provided by a drum (304) having a breaking device (306) and being suitable for storing and feeding a strand (302) consisting of filaments, and
a second unit (B) following the first unit, provided by an outspreading device (308) for outspreading the filaments of the strand (302) consisting of filaments into a band (310), and
a third unit (C) following the second unit, provided by a tank (312) for receiving a liquid emulsive dispersion (314) for wetting the filaments of the band (310), and
a fourth unit (D) following the third unit, provided by a tank (318) for receiving a binding material (322) for coating the filaments of the band (310), and
a fifth unit (E) following the fourth unit, provided by a device (324) for shaping continuously the cross section of the band (310) of filaments having surfaces coated with binding material (322) to form a cable, and
a sixth unit (F) following the fifth unit, provided by a driven drawing reel (328) for pulling the cable (326) having a shaped cross section.

19. Apparatus according to claim 18, characterized in that said outspreading device (308) is formed by blocks having square cross section.

20. Apparatus according to any of claims 18-19, characterized in that guide rolls (320) are arranged in the tank (318) for receiving a binding material (322) for coating the filaments of the band (310).

21. Apparatus according to claim 20, characterized in that the device (324) for shaping is formed as a drawing slit having a rounded, square or oblique cross section.

22. Apparatus according to claim 21, characterized in that the device (324) for shaping is formed as a pair of rollers rotating oppositely on the skirts of each other, both having circumferential grooves forming together the drawing slit.

23. Concrete-composite structure made by the method according to any of claims 13-17, characterized in that the filament is chosen from the group containing carbon fiber, aramid fiber, basalt fiber or a combination thereof, and the binding material (322) is chosen from the group containing cement paste, geopolimer paste or a combination thereof.
